(19) United States
(12) Patent Application Publication
(10) Pub. No.: US 2022/0183126 A1
(43) Pub. Date: Jun. 9, 2022

(54) DRIVELESS LED FIXTURE

(71) Applicant: George Mekhtarian, Hermosa Beach, CA (US)

(72) Inventor: George Mekhtarian, Hermosa Beach, CA (US)

(21) Appl. No.: 17/111,815

(22) Filed: Dec. 4, 2020

(51) Int. Cl. H05B 45/56; H05B 45/46; A01G 7/04

(52) U.S. Cl. CPC H05B 45/56; A01G 7/045; H05B 45/46

(57) ABSTRACT

A group of LED fixtures formed in rows wherein power is delivered to each fixture in the group from a central power unit thus eliminating the necessity of providing a separate power source for each fixture. A circuit is provided to protect the LEDs from excessive temperatures that may result in fire hazards and to bypass a row if an open circuit is detected in the row.

### BACKGROUND OF THE INVENTION

### 1. Field of the Invention

The present invention relates to groups of LED fixtures and, in particular, reducing the cost thereof by centralizing the AC-DC conversion and current control functions.

### 2. Description of the Prior Art

Conventional LED fixtures comprises three major parts:

(a) LED diodes (when mounted on metal clad boards they are often referred to as light modules or light engines);

(b) Driver (provides for AC-to-DC conversion, filtering, transient protection, constant current power supply); and

(c) Housing (primarily used as heat sink).

The fixture can also include secondary optics or lenses.

While LED prices are decreasing, and performance is increasing the drive and housing costs tend to remain the same.

Large commercial installations may utilize hundreds or thousands of LED fixtures, each including its own expensive AC-DC drivers circuit.

Typically, power from the power means are specified at 480V, 60 Hz AC, Triple phase. As noted above, power needs to be supplied to individual fixtures of capital LEDs lights.

Desired LEDs require 16.5VDC at 10 A power to be current regulated and maintain steady at 10 A.

A current method (FIG. 2A) for accomplishing this utilizes individual drivers on each fixture—LED drivers that are connected to the main power line. Power electronics are required to convert AC to DC, step down the voltage and regulate the current to the LEDs. However, this requires expensive electronics for and power line wiring to each fixture.

In a possible alternative (FIG. 2B), a centralized AC-DC system with a step down power source is utilized. A number of fixtures are connected in parallel (for example 20 fixtures) and power is supplied using a large AC-DC power source that delivers 16.5V at 200 amps. However, 200 amps at 16.5VDC requires large gauge (especially over the long distances in a greenhouse installation) which can significantly increase costs and suffer from major line losses, reducing efficiency. The large AC-DC power source is expensive and in the end may not deliver much savings over the current method noted above. In addition, some electronics are still required in each fixture to provide current regulation.

The driveless LED fixture described in U.S. Pat. No. 10,595,387, invented by the inventor of the fixture described in this application, is an improvement to the prior art. In particular, a LED bypass circuit protects the circuit by bypassing a failed open LED fixture that causes an open circuit in a parallel connection of a series of LEDs caused by a large current surge, wear and tear, etc.

Usually the fixture includes a heat sink to allow for this heat to dissipate and keep the fixture within a reasonable working range. Typical fixture thermal design targets a maximum worst case temperature between 65-70 degrees Celsius. Worst case temperature is when the ambient temperature reaches a predetermined operating temperature for the fixtures. Typically for lighting, a 40 degree centigrade worst case ambient is used. Thus at 40 degrees ambient the fixture temperature should not exceed 65-70 degrees centigrade. If the fixture, for some reason exceeds this temperature, LEDS typically fail and become hazards. Fan failure (if the fixture is actively cooled), heat sink cooling fins get blocked or extreme ambient temperatures are examples of what can cause over temperatures. In this situation, the LEDs can be damaged in addition to causing a fire hazard.

What is desired is to provide a multi-LED fixture system wherein the LED fixtures are grouped and wherein the AC-DC conversion process and current control functions are centralized at reduced cost. The system should also provide for continuous operation in case of an open circuits and failure in a LED array from excessive temperatures thus avoiding a fire hazard.

### SUMMARY OF THE INVENTION

The present invention provides a LED fixture system where in the fixtures (or luminaires) are segregated into groups of between 20-30, connected in series, and wherein a power unit is utilized to centralize the capital AC-DC conversion and current controls functions, thus reducing system cost by reducing the number of driver circuits required.

A centralized power source converts the AC power input to a DC between 300 and 500V. Current regulation is performed inside the centralized power source and each central power unit can drive approximately 30 luminaries in series.

A low-cost central power source is utilized without the necessity of individual LED drivers for each fixture and without the need for an electrician to install an individual power box for each fixture. The line losses are minimum since the voltage is high and current relatively low, less than 15 amps.

The present invention provides a LED lighting system array that provides both a thermal bypass circuit such that when the LED fixtures exceed a predetermined temperature a short circuit occurs in the LED array turning them off, thus protecting the LEDs and allowing the fixtures to cool down eliminating a potential fire hazard. A circuit is also provided to bypass an array of LEDs if one of the LEDs an array fails delivering the remaining rows of the arrays to still be functional energized.

### DESCRIPTION OF DRAWINGS

For a better understanding of the present invention as well as other objects and further features thereof, reference is made to the following description which is to be read in conjunction with the accompanying drawing wherein:

FIG. 1 illustrates a perspective view of a conventional LED grow system;

FIG. 2A is simplified block diagram of a prior art power distribution system that can be used in conjunction with the LED grow system shown in FIG. 1;

FIG. 2B is a simplified bloric diagram of a possible power distribution system that could be utilised in the grow system of FIG. 1;

FIG. 2C is a block/circuit diagram of the preferred power distribution system for use with the present invention;

FIG. 3 is a block diagram of the central power source;

FIG. 4 illustrates a circuit diagram that incorporates a design that bypasses the LED array by providing a short circuit condition if there is an open circuit in a row of the LED array or if the fixture that the LED array is coupled to overheats; and

FIGS. 5-8 are simplified representations to further explain the concept of the present invention.

### DESCRIPTION OF THE INVENTION

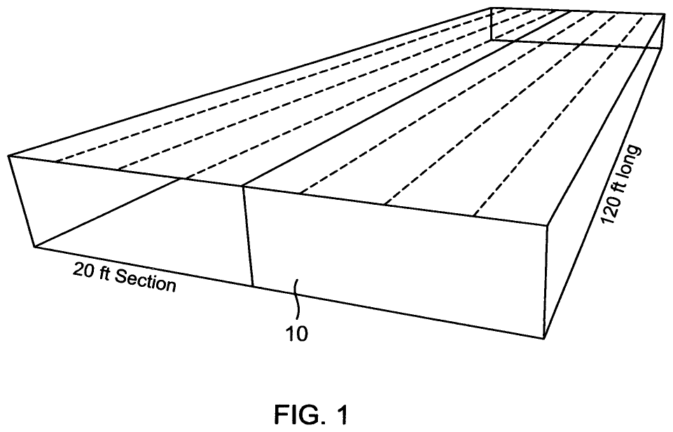

FIG. 1 is a simplified perspective view of a typical greenhouse 10 in which the power distribution system of the present invention can be utilized. Greenhouses, especially when located in the middle and high latitudes, require supplemental artificial lighting in order to grow crops, such as tomatoes, year-round.

The dimensions of a typical section of a greenhouse configuration are as follows:
Length: Typically, between 100 and 120 feet
Width: 20 feet per section width
LED lights: 11, 12, 13 multiple rows (three shown) approximately 4 feet apart in length;

Since light (fixtures) are typically hung every 4 feet, there are from 25 to 30 light fixtures per row.

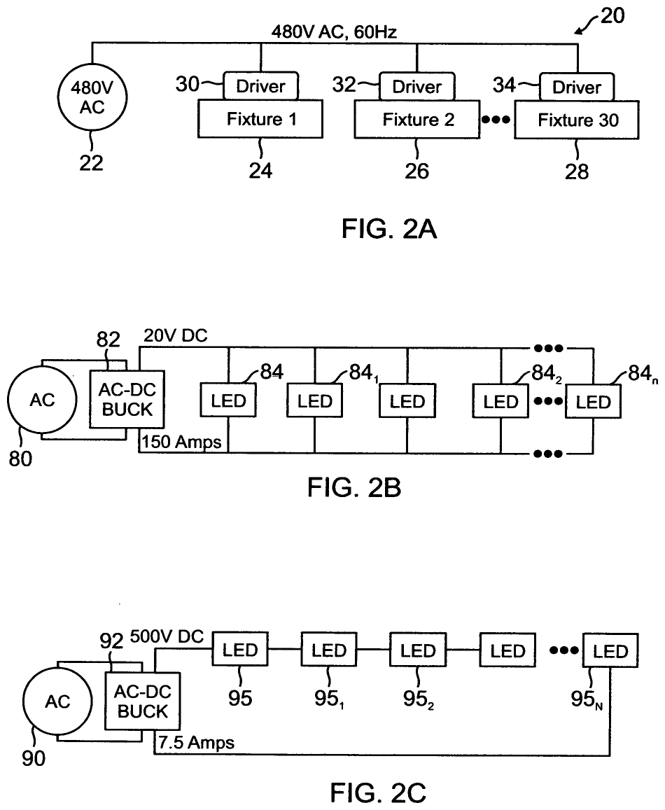

FIG. 2A is a block diagram of a current method for providing power to a power distribution system 20.

System 20 is powered by a source 22 of 480 volts, 60 HzAC of which is coupled to a series of fixtures 24 and 26 and the last fixture 28 in a row via power supply driver circuit 30, 32 and 34, respectively.

FIG. 2B is a block diagram of a power distribution system that may be used in place of the system shown in FIG. 2A. A source of AC power 80 is coupled to step-down device 82 which provides 16.5VDC and 150 amps to a series of LED fixture is 84, 84₁, 84₂, . . . 84n. These fixtures may contain some power electronics for current regulation. In this case, if each LED fixture requires 10 amps, 200 amps is sufficient for 20 fixtures.

The disadvantages of the power distribution system shown in FIG. 2A-2B have been set forth hereinabove.

FIG. 2C illustrates a block diagram of a system as disclosed in the aforementioned U.S. Pat. No. 10,595,387. A source of AC power 90 is coupled to AC-DC converter 92 which generates 500VDC, 10 amp output to a series of LED fixtures 95, 95₁, 95₂, . . . 95n as illustrated. The fixtures simply consist of LEDs mounted on a printed circuit board and coupled to a proper heat sink which can be the fixture housing.

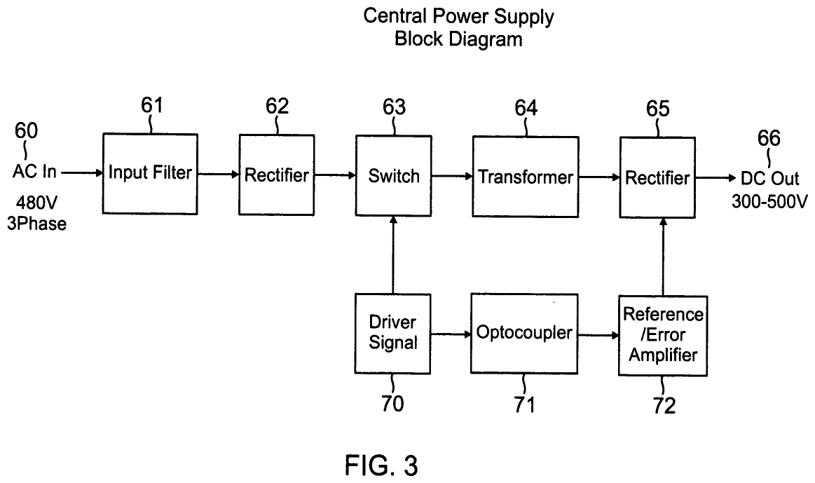

FIG. 3 illustrates a block diagram of the central power unit. Three phase AC at 480V is applied to the unit 60. Power goes through the EMI filter 61 and then through a bridge rectifier 62 to the main switch 63. A transformer 64 provides galvanic isolation. Power from the transformer 64 is then rectified to DC via unit 65 and regulated through a feedback loop consisting of the reference or error amplifier 72, an optocoupler 71, and a driver signal generator 70. The power output of the Central Power Supply Unit appears at 66 and is constant DC 300 to 500V unit max current of 10 Amps.

Specification for central power unit FIG. 3 are as follows:

Power input configuration: Triple phase, 480 Volts
Triple phase, 240 Volts
Two phase, 480 Volts
Two phase, 240 Volts
   Specification for the Drive Circuits are as follows:

480V: 20 to 30 fixtures in series

240V: 12-15 fixtures in series

Input voltage per fixture: 16-20 volts

LED load

Total voltage: 16.5 Volts

Total Amperes: 10 Amps

LED Arrangement: 8×10

Total power. 150 watts

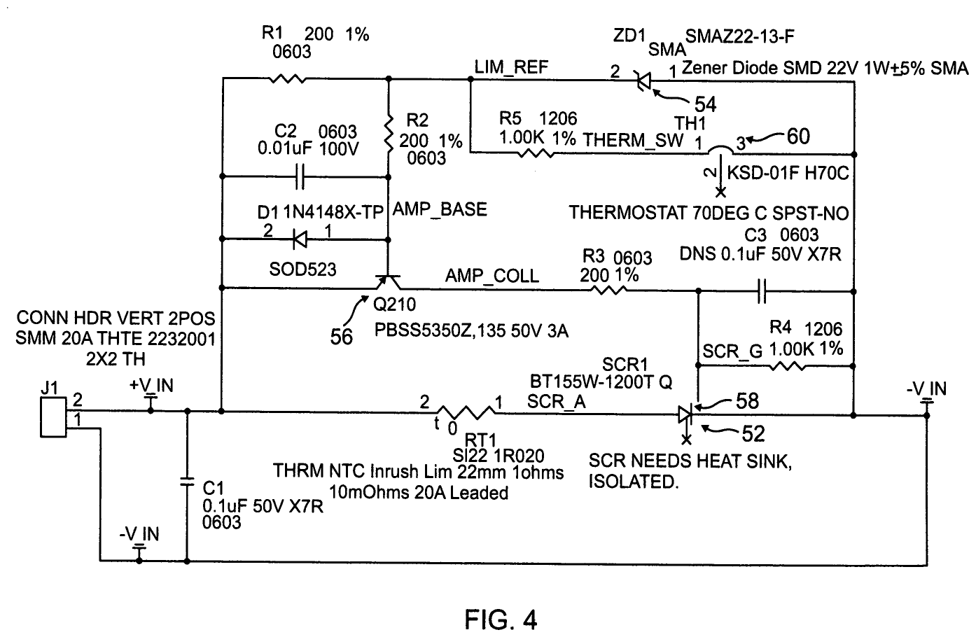

FIG. 4 illustrates the circuit coupled to the LED fixture of the present invention which utilizes both an open circuit and a thermal heat bypass circuit to protect the array from overheating and to short circuit one of the rows forming the array if one of the LEDs in the row fails.

Power is distributed to the fixtures using a 500VDC, 10 amps input, power electronics circuitry thus not being required in the fixtures. The fixtures are driven in series so that in a system of 30 fixtures, each would receive approximately 16.5 volts which minimizes the system insulation required protective circuits are provided to protect the LEDs from open circuits and excessive temperatures as described hereinbelow.

In accordance with teachings of the present invention, connector 11 is coupled to the anode (+V_IN) and cathode (−V_IN) terminals of the LED array (see FIG. 2C). In the case of an open circuit failure, the voltage across 11 will exceed the Zener diode voltage of Zener diode 54 causing it to conduct. This, in turn causes transistor 56 to turn on causing, in turn, the gate pin, or electrode, 58 of SCR 52 to go high. When SCR 52, as a result, is turned on, the +V_IN and −V_IN pins are shorted thus bypassing the LED array.

Thermostat 60 is also connected in parallel with Zener diode 54, the thermostat being physically connected to the fixture. If the fixture temperature exceeds the threshold temperature of thermostat 60 (70 C for example), a short circuit across the terminals of Zener diode 54 results, causing a short circuit across the terminals of Zener diode 54 causing SCR 52 to conduct and bypass the LED array.

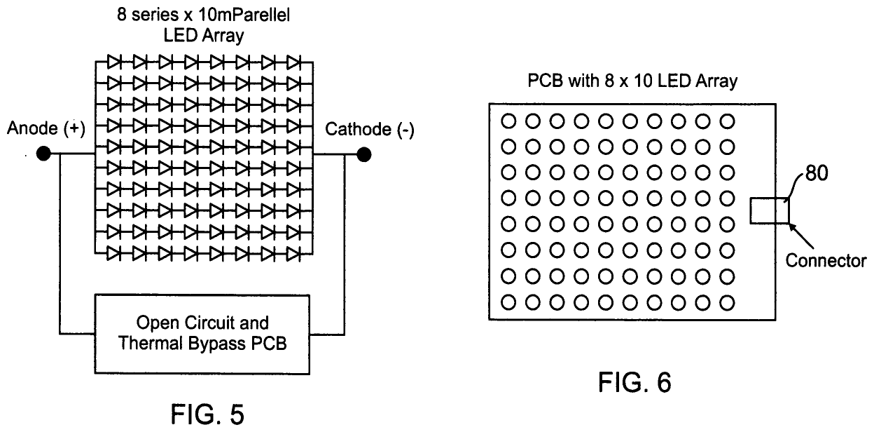

FIGS. 5-8 are simplified illustrations to further explain the operation of the present invention.

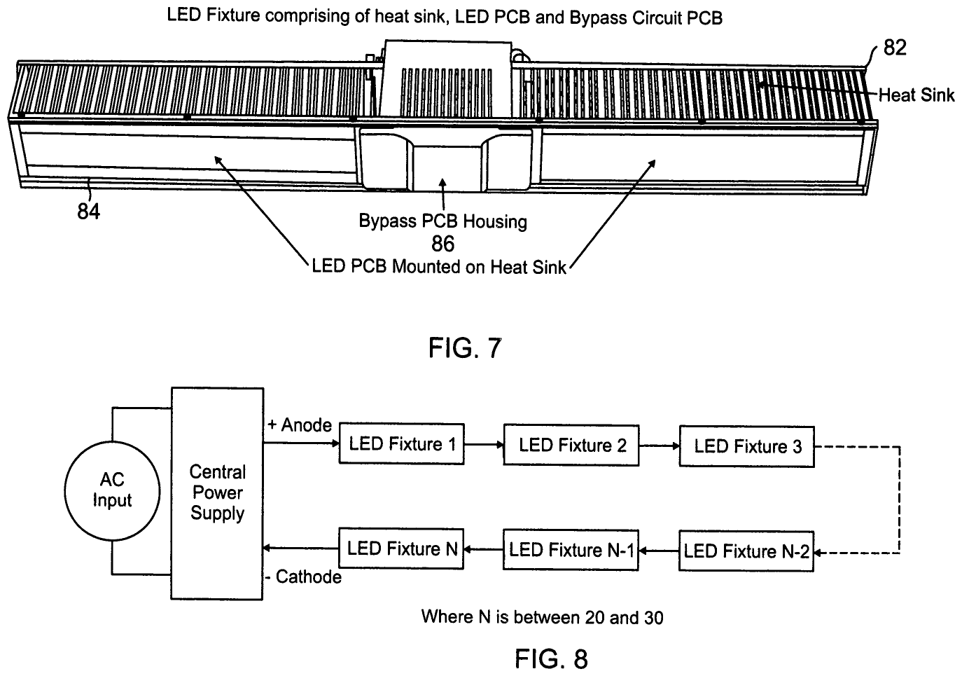

FIG. 5 illustrates a LED array comprising a serial chain of eight LEDs formed in ten parallel rows and an open circuit and thermal bypass printed circuit board (“PCB”); FIG. 6 illustrates a PCB comprising an 8×10 LED array with connector 80 and FIG. 7 illustrates a LED fixture which comprises heat sink 82, LED PCB 84 and the bypass circuit PCB 86.

FIG. 8 illustrates the power connection to the LED fixtures and the operation of the bypass circuit. If, for example, LED fixture 2 fails open circuit without the bypass circuit, the entire chain of fixtures would turn off. The bypass circuit on the other hand, detects the open circuit and shorts out the failed fixture allowing the remaining fixtures in the chain to be energized and operational. If fixture 2 overheats, the bypass circuit shorts the anode and cathode of the LED array of that fixture, turning it off and allowing it to cool down, the remaining fixtures in the chain being energized and operational (in the figure, N is typically between 20 and 30).

The following describes in more detail the basic features of the present invention. The bypass circuit is designed to activate in case the LED circuit on one of the fixtures fails open. In other words, for whatever reason (surge, wear and tear etc.) the array of LEDs in one of the fixtures fails and causes an open circuit. This will happen when a single LED per string of LEDS in the array fails and opens the circuit. Since all the fixtures are connected in series, when one of them fails open circuit, then the rest of the fixtures will no longer get power. The bypass circuit detects this situation and closes the circuit on the fixture that has the failure. This will allow the current to flow through all the rest of the fixtures, the failed fixture not lighting up but the remaining fixtures in the chain will do so. Since the power supply is a current controller, more than one fixture can be bypassed in this fashion and the rest of the fixtures would be operational.

Since LEDs generate heat, the fixtures includes a heat sink to allow for this heat to dissipate and keep the fixture within a reasonable working range. Typical fixture thermal design targets a max worse case temperature of 65-70 degrees Celsius. Worst case temperature occurs when the ambient temperature reaches worst operating temperature for the fixtures. Typically for lighting, a 40 degree Celsius worst case ambient temperature is the design parameter designed at 40 degrees ambient, the fixture temperature should not exceed 65-70 degrees Celsius. If the fixture, for some reason, exceeds this temperature LEDs may fail or if the temperature is too high, the LEDs become fire hazards. High temperatures can be caused by fan failure (if the fixture is actively cooled), heat sink cooling fins get blocked or extreme ambient temperatures occur. In such situations, the thermal bypass portion of the circuit (or switch) bypasses the LEDs (short circuits the LED array) essentially turning them off. This protects the LEDs and allows the fixture to cool down eliminating the fire hazard.

The failed LED bypass portion of the circuit is triggered by high voltage. In the arrangement described hereinabove, 30 fixtures are in series and a total 500v is applied across the whole circuit. That means each fixture sees 500/30=16.67 volts. The Zener diode is selected to become operational when approximately 20V is applied thereacross. When the LED array on a fixture fails open circuit, the full 500V will be present at the terminals of the failed fixture. This exceeds the Zener diode voltage, triggering the FET to turn on and bypass the LED array. For the thermal bypass, an electro-mechanical thermal switch can be utilized. These switches have an internal bi-metallic snap disc and when a certain threshold temperature is reached, the disc snaps, activating the switch. The switch is normally open and closes when the over-temperature situation is reached.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the invention without departing from its essential teachings.

1. A system for illuminating plants to enhance plant growth comprising:
an array having a plurality of LEDs, said LEDs connected in series as a plurality of rows, said rows being connected in parallel;
a printed circuit board, said plurality of LEDs being mounted to said printed circuit board, said LED array being coupled to a first circuit wherein if one or more LEDs fail causing an open circuit, the entire LED array is short circuited and bypassed and a second bypass circuit enabling the LED array to be bypassed if the temperature of any of said rows exceeds a predetermined value;
a plurality of LED fixtures, said printed circuit board being coupled to said LED fixtures; and
a power source couple to said LED fixtures application of power to said LED fixtures causing said LEDs to generate light to enhance the growth of plants exposed to said light.

2. The system of claim 1 further including a central power supply having an input and output, said power source connected to said central power supply, the output of said central power supply being coupled to plurality of LED fixtures that are serially connected, the output of the last LED fixture in series being coupled to the output of said central power supply.

3-4. (canceled)

5. The system of claim 1 wherein said first and second circuits are connected together in a manner such that the LED array is short circuited and bypassed only if an open circuit is detected.

6. The system of claim 1 wherein said first and second circuits are connected together in a manner such the LED array is short circuited and bypassed only if the temperature of any of said rows exceed said predetermined value.
